(19) United States
(12) Patent Application Publication
(10) Pub. No.: US 2026/0304039 A1
(43) Pub. Date: Oct. 1, 2026

(54) ACOUSTIC SYSTEM, ACOUSTIC SYSTEM CONTROL METHOD, AND ACOUSTIC SYSTEM MANUFACTURING METHOD

(71) Applicants: Panasonic Connect Co., Ltd., Fukuoka (JP); Panasonic Automotive Systems Co., Ltd., Kanagawa (JP)

(72) Inventors: Tatsuya SHIMIZU, Hyogo (JP); Koji SANO, Kanagawa (JP); Yasunori MIYAMOTO, Kanagawa (JP); Keisuke FUJIMOTO, Osaka (JP)

(73) Assignees: Panasonic Connect Co., Ltd., Fukuoka (JP); Panasonic Automotive Systems Co., Ltd., Kanagawa (JP)

(21) Appl. No.: 19/452,725

(22) Filed: Jan. 19, 2026

(30) Foreign Application Priority Data
Mar. 28, 2025 (JP) 2025-056341

(51) Int. Cl. H04R 3/02

(52) U.S. Cl. CPC H04R 3/02

(57) ABSTRACT

An acoustic system includes: a loudspeaker device that includes a first loudspeaker including a first diaphragm, and a second loudspeaker including a second diaphragm disposed around the first diaphragm; a first signal output device that outputs a first acoustic signal to the first loudspeaker; and a second signal output device that outputs, to the second loudspeaker, a second acoustic signal obtained by correcting the first acoustic signal to suppress propagation of sound in a non-propagation area that is outside an area in which propagation of the sound is intended, the sound having been emitted from the first loudspeaker based on the first acoustic signal.

### CROSS REFERENCE TO RELATED APPLICATION

The present application is based on and claims priority of Japanese Patent Application No. 2025-056341 filed on Mar. 28, 2025.

### FIELD

The present disclosure relates to an acoustic system that limits the propagation area of a sound, to an acoustic system control method, and to an acoustic system manufacturing method.

### BACKGROUND ART

Patent Literature (PTL) 1 describes an acoustic system that, in a situation where different sounds are emitted from a plurality of loudspeakers disposed at different locations such as in the cabin of an airplane, prevents sound emitted from a loudspeaker other than a predetermined loudspeaker from reaching a person seated close to the predetermined loudspeaker.

### CITATION LIST

### Patent Literature

PTL 1: Japanese U.S. Pat. No. 6,958,763

### SUMMARY

However, the acoustic system described in aforementioned PTL 1 can be improved upon.

The present disclosure provides an acoustic system, an acoustic system control method, and an acoustic system manufacturing method that are capable of improving upon the related art.

An acoustic system according to an aspect of the present disclosure includes: a loudspeaker device that includes a first loudspeaker and a second loudspeaker, the first loudspeaker including a first diaphragm, the second loudspeaker including a second diaphragm disposed around the first diaphragm; a first signal output device that outputs a first acoustic signal to the first loudspeaker; and a second signal output device that outputs, to the second loudspeaker, a second acoustic signal obtained by correcting the first acoustic signal to suppress propagation of sound in a non-propagation area that is outside an area in which propagation of the sound is intended, the sound having been emitted from the first loudspeaker based on the first acoustic signal.

An acoustic system control method according to an aspect of the present disclosure is an acoustic system control method for setting a filter property of a correction filter included in an acoustic system. The acoustic system includes: a loudspeaker device that includes a first loudspeaker and a second loudspeaker, the first loudspeaker including a first diaphragm, the second loudspeaker including a second diaphragm disposed around the first diaphragm; a first signal output device that outputs a first acoustic signal to the first loudspeaker; and a second signal output device that outputs, to the second loudspeaker, a second acoustic signal obtained by correcting the first acoustic signal to suppress propagation of sound in a non-propagation area that is outside an area in which propagation of the sound is intended, the sound having been emitted from the first loudspeaker based on the first acoustic signal. The second signal output device includes a correction filter that corrects the first acoustic signal to output the second acoustic signal to the second loudspeaker; and the correction filter has a filter property that is derived based on a transmission property of propagating sound emitted by the second loudspeaker. The acoustic system control method includes: placing a measurement device in one or more locations inside the non-propagation area; and setting the filter property of the correction filter, based on: a first sound-pressure transfer function between the first acoustic signal and a first measurement signal obtained by way of the measurement device measuring sound emitted from the first loudspeaker based on the first acoustic signal, and a second sound-pressure transfer function between the second acoustic signal and a second measurement signal obtained by way of the measurement device measuring sound emitted from the second loudspeaker based on the second acoustic signal.

An acoustic system manufacturing method according to an aspect of the present disclosure is an acoustic system manufacturing method for manufacturing an acoustic system by setting a filter property of a correction filter included in the acoustic system. The acoustic system includes: a loudspeaker device that includes a first loudspeaker and a second loudspeaker, the first loudspeaker including a first diaphragm, the second loudspeaker including a second diaphragm disposed around the first diaphragm; a first signal output device that outputs a first acoustic signal to the first loudspeaker; and a second signal output device that outputs, to the second loudspeaker, a second acoustic signal obtained by correcting the first acoustic signal to suppress propagation of sound in a non-propagation area that is outside an area in which propagation of the sound is intended, the sound having been emitted from the first loudspeaker based on the first acoustic signal. The second signal output device includes a correction filter that corrects the first acoustic signal to output the second acoustic signal to the second loudspeaker; and the correction filter has a filter property that is derived based on a transmission property of propagating sound emitted by the second loudspeaker. The acoustic system manufacturing method includes: placing a measurement device in one or more locations inside the non-propagation area; and setting the filter property of the correction filter, based on: a first sound-pressure transfer function between the first acoustic signal and a first measurement signal obtained by way of the measurement device measuring sound emitted from the first loudspeaker based on the first acoustic signal, and a second sound-pressure transfer function between the second acoustic signal and a second measurement signal obtained by way of the measurement device measuring sound emitted from the second loudspeaker based on the second acoustic signal.

An acoustic system, an acoustic system control method, and an acoustic system manufacturing method according to an aspect of the present disclosure are capable of improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of an acoustic system.

FIG. 2 is a cross-sectional view of a loudspeaker device included in the acoustic system.

FIG. 3 is a diagram illustrating the functional configuration of the acoustic system.

FIG. 4 is a diagram illustrating a property generation system in a first measurement mode.

FIG. 5 is a diagram illustrating the property generation system in a second measurement mode.

FIG. 6 is a diagram illustrating another example of the property generation system.

### DESCRIPTION OF EMBODIMENTS

Hereinafter, embodiments of an acoustic system, an acoustic system control method, and an acoustic system manufacturing method according to the present disclosure will be described with reference to the Drawings. It should be noted that each of the subsequent embodiments shows an example for describing the present disclosure, and thus is not intended to limit the present disclosure. For example, the shapes, structures, materials, structural components, the relative positional relationships and connections of the structural components, numerical values, formulas, steps, the processing order of the steps, and so on, shown in the following embodiments are mere examples, and details not described below may be included. Furthermore, although there are cases where geometric expressions, such as “parallel” and “orthogonal”, are used, these expressions are not mathematically precise indications and include substantially permissible error, deviation, and the like. Moreover, expressions such as “simultaneous” and “identical (or the same)” are considered to cover a substantially permissible range of meaning.

Additionally, the drawings are schematic illustrations that may include emphasis, omission, or adjustment of proportion as necessary for the purpose of describing the present disclosure, and thus the shapes, positional relationships, and proportions shown may be different from actuality.

Furthermore, hereinafter, multiple inventions may be comprehensively described as a single embodiment. Moreover, part of the contents in the description below is described as an optional element related to the present disclosure.

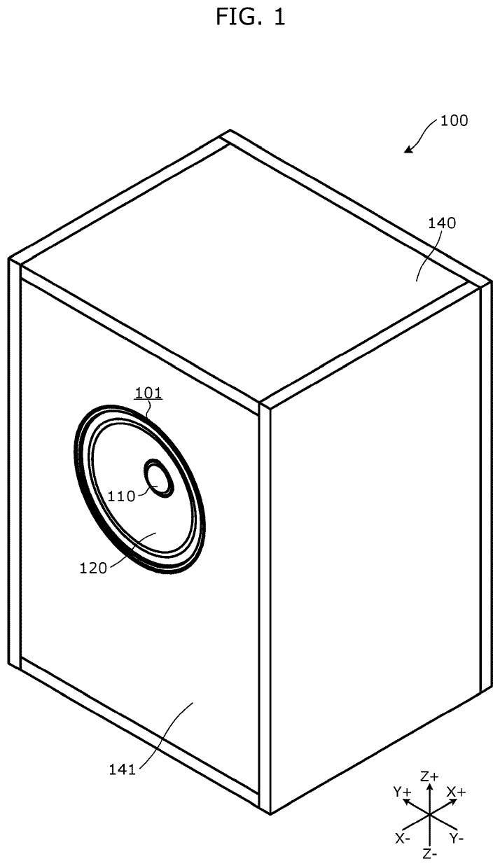

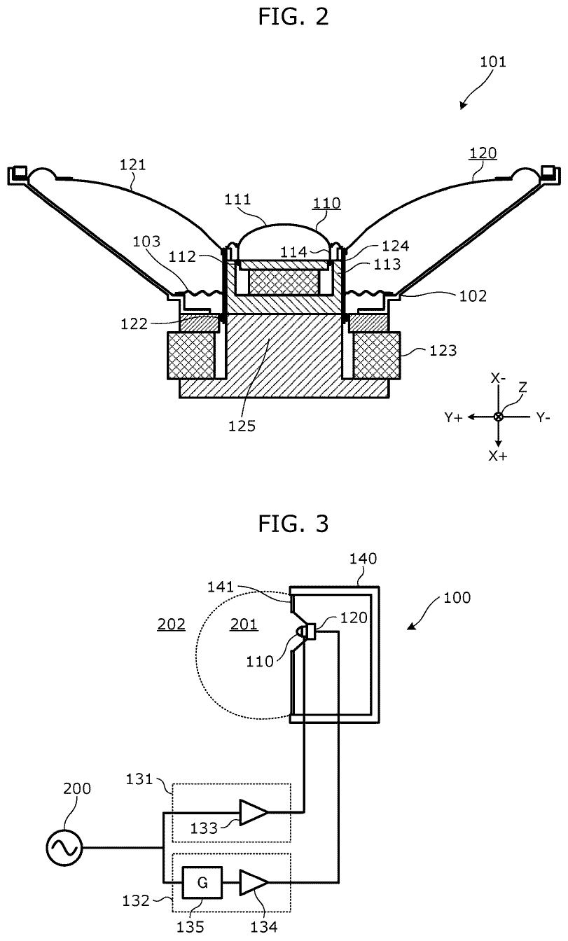

FIG. 1 is a perspective view of acoustic system 100. FIG. 2 is a cross-sectional view of loudspeaker device 101 included in acoustic system 100. FIG. 3 is a diagram illustrating the functional configuration of acoustic system 100. Acoustic system 100 is a system capable of causing propagation of sound in propagation area 201 (see FIG. 3), and suppressing the propagation of sound in non-propagation area 202 which is outside propagation area 201. Acoustic system 100 includes loudspeaker device 101, first signal output device 131, and second signal output device 132. In the present embodiment, acoustic system 100 includes casing 140, and baffle board 141.

Speaker device 101 is a device that includes first loudspeaker 110 that is relatively small, and second loudspeaker 120 that is relatively large. In the present embodiment, loudspeaker device 101 utilizes what is called a coaxial loudspeaker.

First loudspeaker 110 is a device that generates, based on a first acoustic signal, a sound traveling in a predetermined direction. Acoustic system 100 may include one or more first loudspeakers 110. First loudspeaker 110 is a loudspeaker that emits sound in the same direction (X−direction in the figures) as second loudspeaker 120, and includes first diaphragm 111, first voice coil 112, and first magnetic circuit 113.

The shape of first diaphragm 111 is not limited but a dome type is utilized in the present embodiment.

First voice coil 112 is wound around a cylindrical first bobbin 114, and is connected to first diaphragm 111 via first bobbin 114.

The type of first magnetic circuit 113 is not limited but, in the present embodiment, first magnetic circuit 113 is of the inner magnetism type.

Second loudspeaker 120 is a device that generates, based on a second acoustic signal, a sound that travels in the same direction as the sound generated by first loudspeaker 110. Furthermore, acoustic system 100 may include one second loudspeaker 120 or a plurality thereof. Second loudspeaker 120 is a loudspeaker that emits sound from around first loudspeaker 110 in the same direction (X− direction in the figures) as first loudspeaker 110, and includes second diaphragm 121, second voice coil 122, and second magnetic circuit 123.

Second diaphragm 121 is a diaphragm disposed surrounding the circumference of first diaphragm 111. The shape of second diaphragm 121 is not limited but is a cone-type in the present embodiment. A hole is provided at the center of second diaphragm 121, and first loudspeaker 110 is disposed by being inserted through the hole.

Second voice coil 122 is wound around a cylindrical second bobbin 124, and is connected to second diaphragm 121 via second bobbin 124. In the present embodiment, the winding axis of second voice coil 122 is located on the same axis as the winding axis of first voice coil 112. Second bobbin 124 is disposed surrounding the circumference of first loudspeaker 110, and is connected to frame 102 via damper 103.

The type of second magnetic circuit 123 is not limited but, in the present embodiment, second magnetic circuit 123 is of the outer magnetism type, and first magnetic circuit 113 of first loudspeaker 110 is attached at a center hole of second magnetic circuit 123.

In the present embodiment, loudspeaker device 101 is attached to baffle board 141. The material and shape of baffle board 141 is not limited. For example, baffle board 141 can be exemplified by a rectangular plate-shaped component made from one of metal, resin, wood, or other material. Baffle board 141 blocks the opening of rectangular box-shaped casing 140, and is held by casing 140 in such a way that the inside of casing 140 becomes a sealed space. Loudspeaker device 101 is a closed-back loudspeaker in which the back side (X+ side in the figures) of second loudspeaker 120 is housed in a sealed state.

First signal output device 131 is a device that outputs a first acoustic signal to first loudspeaker 110. First signal output device 131, although not limited to this configuration, includes first driving amplifier 133 in the present embodiment. First driving amplifier 133 is an amplifier that amplifies a first acoustic signal outputted from signal source 200, until sound can be emitted from first loudspeaker 110. It should be noted that first signal output device 131 may include any filter such as a delay filter, a correction filter, and so on.

Second signal output device 132 is a device that outputs, to second loudspeaker 120, a second acoustic signal obtained by correcting the first acoustic signal to suppress the propagation of sound, which was emitted from first loudspeaker 110 based on the first acoustic signal, in non-propagation area 202 that is outside propagation area 201 in which propagation of the sound in air is intended. Second signal output device 132, although not limited to this configuration, includes second driving amplifier 134 in the present embodiment. Second driving amplifier 134 amplifies the second acoustic signal that has been corrected to suppress sound emitted by second loudspeaker 120 from propagating to non-propagation area 202. In the present embodiment, second driving amplifier 134 amplifies the second acoustic signal that has been corrected by correction filter 135.

Correction filter 135 is a filter that outputs, to second loudspeaker 120, a second acoustic signal obtained by correcting the first acoustic signal to cause the sound emitted from first loudspeaker 110 to propagate inside propagation area 201 in which propagation of the sound is intended, and to suppress the propagation of sound in non-propagation area 202 to which propagation of the sound is not intended. Propagation area 201 is an area located close to first loudspeaker 110, and non-propagation area 202 is an adjacent area located on a side of propagation area 201 that is farther from first loudspeaker 110 than propagation area 201. Correction filter 135 has an acoustic system 100-specific filter property G. Filter property G of correction filter 135 is derived based on a transmission property of propagating sound emitted second loudspeaker 120.

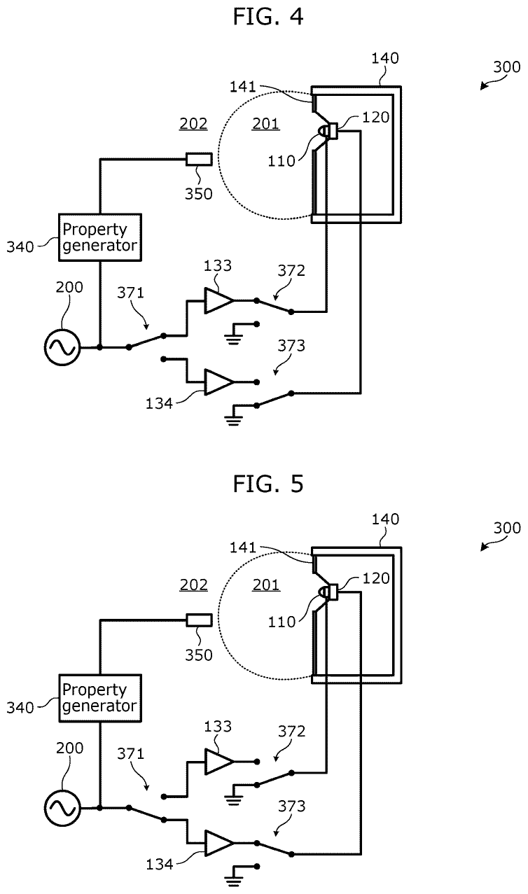

Next, property generation system 300 that is capable of setting filter property G of correction filter 135 included in acoustic system 100 will be described. FIG. 4 is a diagram illustrating property generation system 300 in a first measurement mode. FIG. 5 is a diagram illustrating property generation system 300 in a second measurement mode. Property generation system 300 is a system that generates filter property G of correction filter 135 included in acoustic system 100, and includes: acoustic system 100 whose filter property G is still not set; property generator 340; and measurement device 350. In the present embodiment, acoustic system 100 includes first switch 371, second switch 372, and third switch 373.

The generation of filter property G is executed based on a first acoustic signal used for measuring (hereinafter referred to as a measurement first acoustic signal). For example, as a measurement first acoustic signal, a predetermined acoustic signal, a sine curve signal, a swept sine signal, an impulse signal, a random noise signal, a colored noise signal, an M-sequence signal, a time-stretched pulse (TSP) signal, and so on, can be given as examples.

Measurement device 350 is a device that measures sound generated by acoustic system 100. As measurement device 350 that measures sound, a microphone can be given as an example. It should be noted that, for example, a displacement sensor, a speed sensor, an acceleration sensor, and so on, may be used as measurement device 350.

Measurement device 350 is placed in one or more locations inside non-propagation area 202, and property generator 340 generates filter property G of correction filter 135 based on (I) first sound-pressure transfer function H1 between a first acoustic signal and first measurement signal P1 obtained by measurement device 350 measuring the sound emitted from first loudspeaker 110 based on the first acoustic signal and (ii) second sound-pressure transfer function H2 between a second acoustic signal and second measurement signal P2 obtained by measurement device 350 measuring the sound emitted from second loudspeaker 120 based on the second acoustic signal. In the present embodiment, property generator 340 derives filter property G by using Fourier transform. A specific method of deriving will be described later. Property generator 340 is a processing unit implemented by causing a processor included in a dedicated or general-purpose computer to execute a property generation program.

Next, a method of manufacturing acoustic system 100 using property generation system 300 will be described. As illustrated in FIG. 4, acoustic system 100 is disposed at a predetermined location. Furthermore, measurement device 350 is disposed at the boundary between propagation area 201 and non-propagation area 202.

First switch 371 and second switch 372 are switched so that sound is generated by first loudspeaker 110 according to first acoustic signal S1 (see FIG. 4). At this time, third switch 373 is switched so that second loudspeaker 120 is short-circuited.

First measurement signal P1 is obtained by causing measurement device 350 to measure the sound that was generated from first loudspeaker 110. Property generator 340 derives first sound-pressure transfer function H1 between first acoustic signal S1 and first measurement signal P1.

Next, first switch 371 and third switch 373 are switched so that sound is generated by second loudspeaker 120 based on second acoustic signal S2 (see FIG. 5). At this time, second switch 372 may be switched so that first loudspeaker 110 is short-circuited. It should be noted that second acoustic signal S2 is an uncorrected first acoustic signal S1. In other words, second acoustic signal S2 is the same as first acoustic signal S1.

Second measurement signal P2 is obtained by causing measurement device 350 to measure the sound generated from second loudspeaker 120 based on second acoustic signal S2, without changing the position of measurement device 350 that has measured first measurement signal P1. Property generator 340 derives second sound-pressure transfer function H2 between second acoustic signal S2 and second measurement signal P2, and derives filter property G of correction filter 135 by using second sound-pressure transfer function H2 together with first sound-pressure transfer function H1 derived earlier.

By setting filter property G of correction filter 135 that was generated by property generator 340 to correction filter 135 included in acoustic system 100, acoustic system 100 can be manufactured.

It should be noted that the present invention is not limited to the above-described embodiment. For example, other embodiments that can be realized by arbitrarily combining structural elements described in the present Specification or by removing some of the structural elements may be embodiments of the present disclosure. Furthermore, variations obtainable through various modifications to the above-described embodiment that can be conceived by a person of ordinary skill in the art without departing from the essence of the present disclosure, that is, the meaning of the recitations in the Claims are included in the present disclosure.

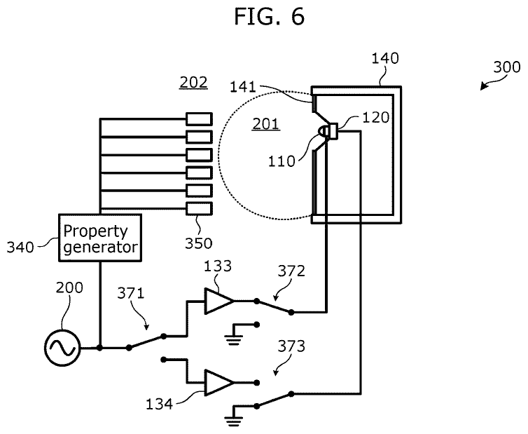

For example, although the case where filter property G for correction filter 135 is derived with first measurement signal P1 and second measurement signal P2 being measured by measurement device 350 disposed in one location, as illustrated in FIG. 6, filter property G may be derived by measuring a plurality of first measurement signals P1 and a plurality of second measurement signals P2 by placing a plurality of measurement devices 350 at multiple positions or by changing the position of measurement device 350. In this case, filter property G of the correction filter may be derived based on (i) first sound-pressure transfer function H1 between first acoustic signal S1 and a first processed signal obtained by performing statistical processing on first measurement signals P1 measured at a number of positions that are different from the number of first loudspeaker 110 and (ii) second sound-pressure transfer function H2 between second acoustic signal S2 and a second processed signal obtained by performing statistical processing on second measurement signals P2 measured at a number of positions that is different from the number of second loudspeaker 120.

Furthermore, although a case is exemplified in which acoustic system 100 is manufactured by setting, to correction filter 135, filter property G derived from measurement results based on property generation system 300, filter property G of correction filter 135 may be derived through numerical analysis simulation such as Finite Element Method (FEM) or Limit Equilibrium Method (LEM: equilibrium circuit analysis method that uses lumped element) and set to correction filter 135 of acoustic system 100.

Furthermore, a case has been described in which, in property generation system 300, second switch 372 and third switch 373 are disposed on the output terminal side of first driving amplifier 133 and second driving amplifier 134, second switch 372 and third switch 373 may be disposed on the input terminal side of first driving amplifier 133 and second driving amplifier 134. In this case, when a voltage-driven amplifier having a sufficiently low output impedance is used as a measurement amplifier, short-circuiting to the ground potential of the measurement amplifier input terminal can achieve the same effect as short-circuiting a switch disposed on the output terminal side.

Furthermore, the type of first magnetic circuit 113 of first loudspeaker 110 and the type of second magnetic circuit 123 of second loudspeaker 120 are not limited. The type of first magnetic circuit 113 and the type of second magnetic circuit 123 may be the same, or they may be different.

### Conclusion

Acoustic system 100 according to a first aspect includes: a loudspeaker device that includes first loudspeaker 110 including first diaphragm 111, and second loudspeaker 120 including second diaphragm 121 disposed around first diaphragm 111; a first signal output device that outputs a first acoustic signal to first loudspeaker 110; and a second signal output device that outputs, to second loudspeaker 120, a second acoustic signal obtained by correcting the first acoustic signal to suppress propagation of sound in a non-propagation area that is outside an area in which propagation of the sound is intended, the sound having been emitted from the first loudspeaker based on the first acoustic signal.

According to the first aspect, sound can be propagated in propagation area 201 which is an intended area close to loudspeaker device 101, and propagation of sound can be suppressed in non-propagation area 202 which is an area for which the propagation of sound had been difficult to suppress with a conventional device and method. Therefore, it is possible to create an arbitrary space in which the sound reaches only a person inside propagation area 201 close to acoustic system 100, and the sound does not easily reach a person outside propagation area 201. As such a space, it is possible to create, for example, in the cabin of an airplane or the cabin of a car, a space where sound can reach a person sitting in a predetermined seat, and a person sitting in a different seat can listen to a different sound or enjoy a conversation.

Acoustic system 100 according to a second aspect is acoustic system 100 according to the first aspect, in which, the second signal output device includes a correction filter that corrects the first acoustic signal to output the second acoustic signal to second loudspeaker 120, and the correction filter has a filter property that is derived based on a transmission property in a vicinity of a propagation area of sound emitted by second loudspeaker 120 using second diaphragm 121.

Acoustic system 100 according to a third aspect is acoustic system 100 according to the first or second aspect, in which, the second signal output device includes a correction filter that corrects the first acoustic signal to output the second acoustic signal to second loudspeaker 120, and the correction filter has a filter property that is derived based on a transmission property of propagating sound emitted by second loudspeaker 120.

Acoustic system 100 according to a fourth aspect is acoustic system 100 according to any one of the first to third aspects, in which, in a plan view, a position of a sound source of first loudspeaker 110 coincides with a position of a sound source of second loudspeaker 120.

According to the fourth aspect, the propagation area of a sound can be precisely limited.

Acoustic system 100 according to a fifth aspect is acoustic system 100 according to any one of the first to fourth aspects, in which, first loudspeaker 110 is disposed at a center portion of second loudspeaker 120 and is joined to an upper portion of second magnetic circuit 123 of second loudspeaker 120.

According to the fifth aspect, the propagation area of a sound can be precisely limited by using a simple structure.

Acoustic system 100 according to a sixth aspect is acoustic system 100 according to any one of the first to fifth aspects, in which, the loudspeaker device is a coaxial loudspeaker.

According to the sixth aspect, by using a coaxial two-way type coaxial loudspeaker device in which first loudspeaker 110 and second loudspeaker 120 are integrally configured in advance, implementation using a simple configuration becomes possible, and thus the manufacturing process can be simplified and cost reduction can be realized.

Acoustic system 100 according to a seventh aspect is acoustic system 100 according to the sixth aspect, in which, in the coaxial loudspeaker, in a cross-sectional view, a height of first diaphragm 111 falls within a range defined by a height of second diaphragm 121.

According to the seventh aspect, in both plan view and cross-sectional view, the positions of the respective sound sources of first loudspeaker 110 and second loudspeaker 120 can be made to approximate each other in the height direction, and thus the propagation area of a sound can be precisely limited.

Acoustic system 100 according to an eighth aspect is acoustic system 100 according to the sixth aspect, in which, in the coaxial loudspeaker, in a cross-sectional view, a position of first diaphragm 111 in a height direction is approximately same as a position of second diaphragm 121 in the height direction.

According to the eighth aspect, the positions of the respective sound sources of first loudspeaker 110 and second loudspeaker 120 can be made approximately the same, and thus the propagation area of a sound can be precisely limited.

Acoustic system 100 according to a ninth aspect is acoustic system 100 according to any one of the first to eighth aspects, in which, first diaphragm 111 is of a dome type.

According to the ninth aspect, the diffusion performance of the sound from first loudspeaker 110 can be improved, and thus the propagation area of the sound can be precisely limited.

An acoustic system control method according to a tenth aspect is an acoustic system control method for setting the filter property of the correction filter included in acoustic system 100 according to the third aspect. The acoustic system control method includes: placing a measurement device in one or more locations inside the non-propagation area; and setting the filter property of the correction filter, based on: a first sound-pressure transfer function between the first acoustic signal and a first measurement signal obtained by way of the measurement device measuring sound emitted from first loudspeaker 110 based on the first acoustic signal; and a second sound-pressure transfer function between the second acoustic signal and a second measurement signal obtained by way of the measurement device measuring sound emitted from second loudspeaker 120 based on the second acoustic signal.

An acoustic system manufacturing method according to an eleventh aspect is an acoustic system manufacturing method for manufacturing acoustic system 100 according to the third aspect by setting the filter property of the correction filter included in acoustic system 100. The acoustic system manufacturing method including: placing measurement device 350 in one or more locations inside the non-propagation area; and setting the filter property of the correction filter, based on: a first sound-pressure transfer function between the first acoustic signal and a first measurement signal obtained by way of the measurement device measuring sound emitted from first loudspeaker 110 based on the first acoustic signal; and a second sound-pressure transfer function between the second acoustic signal and a second measurement signal obtained by way of the measurement device measuring sound emitted from second loudspeaker 120 based on the second acoustic signal.

According to the tenth aspect and the eleventh aspect, it is possible to appropriately set filter property G of correction filter 135 that corresponds to acoustic system 100. Accordingly, sound emitted from first loudspeaker 110 can be propagated in propagation area 201 which is an intended area, and propagation of the sound to non-propagation area 202 can be suppressed.

An acoustic system manufacturing method according to a twelfth aspect is the acoustic system manufacturing method according to the eleventh aspect, that further includes: obtaining the first measurement signal in a state in which second loudspeaker 120 is short-circuited.

An acoustic system manufacturing method according to a thirteenth aspect is the acoustic system manufacturing method according to the eleventh or twelfth aspect, that further includes: obtaining the second measurement signal in a state in which first loudspeaker 110 is short-circuited.

According to the twelfth aspect and the thirteenth aspect, it is possible to suppress the effect on the measurement that is imparted by second loudspeaker 120 or first loudspeaker 110 that is not running.

An acoustic system manufacturing method according to a fourteenth aspect is the acoustic system manufacturing method according to the eleventh to thirteenth aspects, in which, in the setting of the filter property of the correction filter, the filter property is set based on: a first sound-pressure transfer function between the first acoustic signal and a first processed signal obtained by performing statistical processing on first measurement signals measured at a plurality of positions; and a second sound-pressure transfer function between the second acoustic signal and a second processed signal obtained by performing statistical processing on second measurement signals measured at a plurality of positions.

When the number of measurement signals (i.e., the number of measurement positions) and the number of first loudspeaker 110 or second loudspeaker 120 that is running during the measurement match, there is a possibility that an unintended processed signal is created because the derived filter property G is uniquely determined. In contrast, according to the fourteenth aspect, by adopting a configuration in which the number of measurement signals (the number of measurement positions) and the number of second loudspeaker 120 do not match, an unintended processed signal is not created, and a robust correction filter can be calculated.

### Further Information About Technical Background to This Application

The disclosure of the following patent application including specification, drawings, and claims is incorporated herein by reference in its entirety: Japanese Patent Application No. 2025-056341 filed on Mar. 28, 2025.

### Industrial Applicability

The present disclosure is usable in an acoustic system, or the like, that is disposed in a space where people are densely gathered such as in the cabin of an airplane, the cabin of an automobile, an office, a restaurant, and so on.

1. An acoustic system comprising:
a loudspeaker device that includes a first loudspeaker and a second loudspeaker, the first loudspeaker including a first diaphragm, the second loudspeaker including a second diaphragm disposed around the first diaphragm;
a first signal output device that outputs a first acoustic signal to the first loudspeaker; and
a second signal output device that outputs, to the second loudspeaker, a second acoustic signal obtained by correcting the first acoustic signal to suppress propagation of sound in a non-propagation area that is outside an area in which propagation of the sound is intended, the sound having been emitted from the first loudspeaker based on the first acoustic signal.

2. The acoustic system according to claim 1, wherein
the second signal output device includes:
a correction filter that corrects the first acoustic signal to output the second acoustic signal to the second loudspeaker, and
the correction filter has a filter property that is derived based on a transmission property in a vicinity of a propagation area of sound emitted by the second loudspeaker using the second diaphragm.

3. The acoustic system according to claim 1, wherein
the second signal output device includes:
a correction filter that corrects the first acoustic signal to output the second acoustic signal to the second loudspeaker, and
the correction filter has a filter property that is derived based on a transmission property of propagating sound emitted by the second loudspeaker.

4. The acoustic system according to claim 1, wherein
in a plan view, a position of a sound source of the first loudspeaker coincides with a position of a sound source of the second loudspeaker.

5. The acoustic system according to claim 1, wherein
the first loudspeaker is disposed at a center portion of the second loudspeaker and is joined to an upper portion of a second magnetic circuit of the second loudspeaker.

6. The acoustic system according to claim 1, wherein
the loudspeaker device is a coaxial loudspeaker.

7. The acoustic system according to claim 6, wherein
in the coaxial loudspeaker, in a cross-sectional view, a height of the first diaphragm falls within a range defined by a height of the second diaphragm.

8. The acoustic system according to claim 6, wherein
in the coaxial loudspeaker, in a cross-sectional view, a position of the first diaphragm in a height direction is approximately same as a position of the second diaphragm in the height direction.

9. The acoustic system according to claim 1, wherein
the first diaphragm is of a dome type.

10. An acoustic system control method for setting the filter property of the correction filter included in the acoustic system according to claim 3, the acoustic system control method comprising:
placing a measurement device in one or more locations inside the non-propagation area; and
setting the filter property of the correction filter, based on:
a first sound-pressure transfer function between the first acoustic signal and a first measurement signal obtained by way of the measurement device measuring sound emitted from the first loudspeaker based on the first acoustic signal; and
a second sound-pressure transfer function between the second acoustic signal and a second measurement signal obtained by way of the measurement device measuring sound emitted from the second loudspeaker based on the second acoustic signal.

11. An acoustic system manufacturing method for manufacturing the acoustic system according to claim 3 by setting the filter property of the correction filter included in the acoustic system, the acoustic system manufacturing method comprising:
placing a measurement device in one or more locations inside the non-propagation area; and
setting the filter property of the correction filter, based on:
a first sound-pressure transfer function between the first acoustic signal and a first measurement signal obtained by way of the measurement device measuring sound emitted from the first loudspeaker based on the first acoustic signal; and
a second sound-pressure transfer function between the second acoustic signal and a second measurement signal obtained by way of the measurement device measuring sound emitted from the second loudspeaker based on the second acoustic signal.

12. The acoustic system manufacturing method according to claim 11, further comprising:
obtaining the first measurement signal in a state in which the second loudspeaker is short-circuited.

13. The acoustic system manufacturing method according to claim 11, further comprising:
obtaining the second measurement signal in a state in which the first loudspeaker is short-circuited.

14. The acoustic system manufacturing method according to claim 11, wherein
in the setting of the filter property of the correction filter, the filter property is set based on:
a first sound-pressure transfer function between the first acoustic signal and a first processed signal obtained by performing statistical processing on first measurement signals measured at a plurality of positions; and
a second sound-pressure transfer function between the second acoustic signal and a second processed signal obtained by performing statistical processing on second measurement signals measured at a plurality of positions.
